(19) United States
(12) Patent Application Publication
(10) Pub. No.: US 2015/0251907 A1
(43) Pub. Date: Sep. 10, 2015

(54) PLANT AND PROCESS FOR PRODUCING SYNTHESIS GAS

(71) Applicant: LINDE AKTIENGESELLSCHAFT, München (DE)

(72) Inventor: Klemens Wawrzinek, Munich (DE)

(21) Appl. No.: 14/431,333

(22) PCT Filed: Sep. 18, 2013
(86) PCT No.: PCT/EP2013/002810

§ 371 Date: Mar. 26, 2015

(30) Foreign Application Priority Data
Oct. 2, 2012 (DE) 10 2012 019 382.3

(51) Int. Cl. C01B 3/38; B01J 19/00; B01J 19/24

(52) U.S. Cl. CPC C01B 3/38; B01J 19/2415; B01J 19/0013; B01J 2219/00063; B01J 2219/00123; B01J 2219/24; B01J 2219/00164; C01B 2203/0233; C01B 2203/0877; C01B 2203/0811; C01B 2203/1241

(57) ABSTRACT

A method and an apparatus for producing synthesis gas from a feedstock stream, in which the feedstock stream comprising hydrocarbon and steam is introduced into a reformer tube of a steam reformer to generate synthesis gas. The feedstock stream is mixed with H₂O prior to introduction into the reformer tube in order to cool the feedstock stream.

The invention relates to a method for producing synthesis gas from a feedstock stream, in which the feedstock stream comprising hydrocarbon and steam is introduced into a reformer tube of a steam reformer to generate synthesis gas.

The invention additionally relates to an apparatus for carrying out the method according to the invention.

Apparatuses of the above-mentioned type may for example comprise a steam reformer for generating synthesis gas, said steam reformer comprising a combustion chamber, through which at least one reformer tube passes. The heat needed to generate synthesis gas is generated in the combustion chamber, by burning a combustion fuel at an upper end of the combustion chamber. A feedstock stream (feed) comprising hydrocarbon and steam is introduced into the at least one reformer tube and converted into synthesis gas with the assistance of a catalyst arranged in the at least one reformer tube, e.g. in the case of methane (feed) according to:

CH₄+H₂O [symbol] CO+3H₂

Here H₂O is preferably added in excess, in order on the one hand to prevent coke formation and on the other hand to operate the installation with maximally ideal product composition and energy efficiency.

Depending on the composition of the feedstock stream, said feedstock stream must be at a specific temperature, in order to achieve maximally complete conversion of the feedstock stream into synthesis gas. The feedstock stream is therefore preferably adjusted to an appropriate inlet temperature prior to entry into the at least one reformer tube. To set the desired inlet temperature, the feedstock stream is subdivided into a sub-stream which is to be cooled and a sub-stream which is not to be cooled. The sub-stream of the feedstock stream which is to be cooled is passed through on or more heat exchangers (“trim coolers”), in which the sub-stream of the feedstock stream to be cooled indirectly transfers its heat to a cooling medium and is then recombined with the sub-stream of the feedstock stream which is not in be cooled and which has not been passed through the at least one trim cooler. For the purpose of heating, the combined feedstock stream is then passed through a heat exchanger (“superheater”), which is arranged in the combustion chamber of the steam reformer furnace. Through closed-loop control (for example feedback loop) with the temperature sensor at the reformer tube inlet, it is possible, by means of controllable valves, variably to adjust the sub-streams of the feedstock stream which are and are not to be cooled, such that the desired inlet temperature of the feedstock stream is set at the inlet of the at least one reformer tube.

Taking this as a basis, the problem underlying the present invention is therefore that of providing a comparatively inexpensive method of the above type and a comparatively inexpensive apparatus for carrying out the method.

The problem of interest is solved according to the invention, with regard to the method, in that the feedstock stream is mixed with H₂O prior to being introduced into the reformer tube to cool the feedstock stream.

According thereto, the feedstock stream is cooled prior to introduction thereof into the reformer tube by exposing the feedstock stream to liquid H₂O, Said water may here in particular be introduced via at least one nozzle into the feedstock stream. On introduction, the cooling water is in particular vaporized, resulting in the necessary cooling.

The H₂O injected for cooling purposes is preferably of good quality (boiler feed water quality) with a particularly low chloride content, such that for example a conductivity is present downstream of a strongly acidic cation exchanger which is lower than 1 μS/cm, 0.4 μS/cm or 0.2 μS/cm.

Provision is preferably made for the feedstock stream to be introduced into the at least one reformer tube via at least one heat exchanger arranged in the furnace combustion chamber to preheat the feedstock stream, wherein, to cool the feedstock stream, said feedstock stream is preferably mixed with said water upstream of the heat exchanger, in particular outside the combustion chamber or outside the furnace.

In a further embodiment of the invention, an actual temperature of the feedstock stream is finally measured prior to entry thereof into the reformer tube arid compared with a predefinable setpoint temperature, wherein, if the actual temperature exceeds the setpoint temperature, H₂O is admixed to the feedstock stream in order to bring the actual temperature into line with the setpoint temperature.

Moreover, the H₂O introduced in liquid form is preferably included in the balance, such that the reformer may be operated with the minimum possible water content/excess according to the reaction equation explained above (or a corresponding reaction equation in the case of another hydrocarbon).

To this end, the injected quantity of water is preferably measured and/or calculated and taken into account on mixing the feed gas containing steam and hydrocarbon, such that the injected (initially liquid) water results, together with the steam contained in the feed gas, in a total water content of the feedstock stream which at least complies with the stoichiometry of said reaction equation, an excess of water preferably being present (see above).

In this way, the installation temperature-controlled in accordance with the method stated here may be operated with an optimum ratio of steam (liquid H₂O plus H₂O in the feed stream) to gas.

The invention further relates to an apparatus for producing synthesis gas with:
a furnace, which comprises a combustion chamber,
a reformer tube arranged in the combustion chamber for receiving a feedstock stream comprising hydrocarbon and steam,
a pipe connected to the reformer tube for feeding the feedstock stream into the reformer tube.

The problem of interest is solved according to the invention, with regard to the apparatus, in that the apparatus comprises a means designed to introduce H₂O for cooling the feedstock stream into the pipe for feeding the feedstock stream into the reformer tube.

According thereto, a means is provided which is designed to introduce water for cooling the feedstock stream into the pipe or to mix it with the feedstock stream.

In one embodiment of the apparatus, the pipe comprises a first portion and a second portion connected thereto, at least portions of the first portion of the pipe extending outside the combustion chamber or the furnace and being connected to at least one heat exchanger arranged in the combustion chamber, such that a feedstock stream situated in the pipe may be passed through the at least one heat exchanger and in so doing may be heated by indirect heat transfer (for example against another material stream to be cooled), and at least portions of the second portion of the pipe likewise extending outside the combustion chamber or the furnace and connecting the heat exchanger to the at least one reformer tube, such that the correspondingly heated feedstock stream may be fed into the at least one reformer tube.

The combustion chamber of the furnace (relative to a properly arranged furnace state) preferably comprises an upper region and a lower region connected thereto, heat being generated in the upper region by burning a combustion fuel and the lower region accommodating the at least one heat exchanger.

In one variant of the invention, the at least one reformer tube extends in a vertical direction from the upper region of the combustion chamber down into the lower region of the combustion chamber and comprises in the upper region an inlet for feeding the feedstock stream into the reformer tube.

The means for cooling the feedstock stream is preferably arranged at least in part in the first portion of the pipe, specifically preferably in a region of the first portion of the pipe located outside the furnace. This first portion is preferably of a length which makes it possible, under the given conditions, for the H₂O introduced into the pipe to be completely vaporized prior to entry into the heat exchanger (and prior to entry into the reformer).

When using nozzles to inject the water with particularly good spray behaviour, the first portion of the pipe may be kept as short as possible and for example have a length of 0.2×steam velocity (of the feedstock stream) in metres or 0.15×steam velocity (of the feedstock stream) in metres.

If this first portion of the pipe is shorter than the necessary lines for the conventionally used method with trim coolers, heat losses are lower, such that the overall installation may consequently be operated more favourably in energy terms.

Furthermore, the means for cooling the feedstock stream is preferably connected to an inflow line, via which water used for cooling may be supplied to said means.

In one embodiment of the invention, the inflow line additionally comprises a valve, which is designed to adjust an amount of water to be fed per unit time to the means.

The installation preferably further comprises a control unit for opening or closing the valve, which interacts with a temperature sensor provided on the second portion of the pipe for detecting an actual temperature of the feedstock stream and to this end is designed to control the valve (i.e. open and close it) in such a way that the actual temperature is cooled or optionally heated to the predefinable setpoint temperature.

Further details and advantages of the invention will be explained by the following description of the figures, in which:

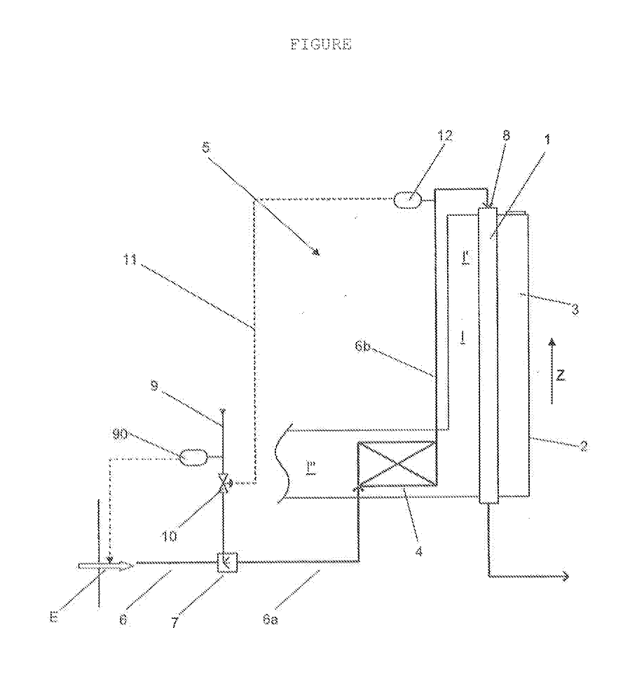

FIG. 1 is a schematic representation of an apparatus according to the invention for producing synthesis gas.

FIG. 1 shows an apparatus (installation) 5 for producing a synthesis gas by means of a steam reformer 2, which comprises at least one reformer tube 1 arranged in a combustion chamber 1 of a furnace 3, into which reformer tube a feedstock stream E, consisting of at least one hydrocarbon and steam, is fed by means of a pipe 6. The combustion chamber I comprises an upper region I′, at the upper end of which head is generated for example by means of at least one burner by burning a combustion fuel, said upper region I′ extending lengthwise in the vertical direction Z, and a lower region I″ connected thereto, which branches off from the upper region I′ transversely to the vertical direction Z, such that the combustion chamber I in particular has an L-shaped profile.

The at least one reformer tube 1 here extends (relative to a properly arranged (operational) state of the apparatus 5) in the vertical direction Z from the upper region I′ of the combustion chamber 1 downwards into the lower region I″ of the combustion chamber I.

The feedstock stream E is then fed from the top of the furnace 3 through an inlet 8 into the at least one reformer tube 1 and passed through and in the process converted into synthesis gas with the assistance of a catalyst arranged in the at least one reformer tube 1, Before it is fed into the at least one reformer tube 1, the feedstock stream E is adjusted to a particular temperature. To this end, there are provided a means 7 for cooling the feedstock stream E and at least one heat exchanger 4 for heating the feedstock stream E, which is arranged in the lower region I″ of the combustion Chamber I which branches off from the upper region I′ of the combustion chamber I.

The cooling means 7 is preferably arranged in a first portion 6a of the pipe 6, portions of which are located outside the furnace 3 or the combustion chamber I. In particular, the means 7 for cooling the feedstock stream E is arranged on a first portion of the pipe 6a which lies outside the furnace 3 or the combustion chamber I.

The cooling water is introduced into the means 7 via an inflow line 9. The amount of water which is admixed to the feedstock stream E per unit time by the cooling means 7 is preferably adjusted by means of a controllable valve 10 in the inflow line 9, said valve being located upstream of the cooling means 7. Downstream of the means 7 bar cooling the feedstock stream E, the first portion 6a of the pipe 6 opens into the heat exchanger 4 provided in the lower region I″ of the combustion chamber I of the furnace 3, in which heat exchanger the feedstock stream E is heated. A second portion 6b of the pipe 6 connects the heat exchanger 4 to the inlet 8 for introducing the heated feedstock stream E into the reformer tube 1. In particular, portions of the second portion 6b of the pipe 6 extend outside the furnace 3 or the combustion chamber I.

(033) To adjust the temperature of the feedstock stream E, a control unit 11 is provided, which cooperates with a temperature sensor 12 arranged on a region of the second portion 6b of the pipe 6 located outside the furnace 3 or the combustion chamber I and is configured to detect the instantaneous temperature (actual temperature) of the feed stream E (at this point) and to forward it to the control unit 11, which is provided and designed to open or close the valve 10, such that the actual temperature can be brought into line with a predefined setpoint temperature of the feedstock stream E.

Furthermore, the instantaneous mass flow rate of the liquid H₂O is measured by means of a measurement device 90 prior to injection into the first portion 6a of the pipe 6, so as to be able to take account of the injected H₂O on mixing of the feedstock stream E. The latter contains a correspondingly lower mass flow rate of steam. The total water content in the feedstock stream E may thus be adjusted precisely to the respectively desired, ideal ratio of hydrocarbon to steam (according to the stoichiometry of the respective reaction equation), water preferably being in excess (see above). Where the feedstock is methane or other hydrocarbons or gas, this ratio is therefore preferably greater than 1, in particular greater than 1.8, in particular 2.0, in particular 2.3, in particular 2.8.

### LIST OF REFERENCE SIGNS

| | |
|---|---|
| 1 | Reformer tube |
| 2 | Steam reformer |
| 3 | Furnace chamber |
| 4 | Heat exchanger |
| 5 | Installation for producing synthesis gas |
| 6 | Pipe |
| 6a | First portion of the pipe |
| 6b | Second portion of the pipe |
| 7 | Means for cooling the feedstock stream |
| 8 | Inlet for feeding in the feedstock stream |
| 9 | Inflow line for H₂O |
| 10 | Valve |
| 11 | Control unit for controlling the valve |
| 12 | Temperature sensor |
| 90 | Means for measuring a mass flow rate |
| E | Feedstock stream |
| I | Combustion chamber (furnace interior) |
| I′ | Upper portion |
| I″ | Lower portion |
| Z | Vertical direction |

1. Method for producing synthesis gas from a feedstock stream, in which the feedstock stream comprising hydrocarbon and steam is introduced into a reformer tube of a steam reformer to produce synthesis gas, characterized in that the feedstock stream is mixed with H₂O prior to being introduced into the reformer tube to cool the feedstock stream.

2. Method according to claim 1, characterized in that the reformer tube is arranged in a combustion chamber of a furnace of the steam reformer, the feedstock stream being introduced into the reformer tube via a heat exchanger arranged in the combustion chamber to preheat the feedstock stream, and the feedstock stream being mixed with said H₂O upstream of the heat exchanger to cool the feedstock stream, the feedstock stream in particular being mixed with said H₂O outside the combustion chamber to cool the feedstock stream.

3. Method according to claim 1, characterized in that H₂O is liquid H₂O and is injected into the feed stream to mix the H₂O with the feed stream.

4. Method according to claim 2, characterized in that an actual temperature of the feedstock stream is measured before the feedstock stream is fed into the reformer tube, said actual temperature being measured downstream of the heat exchanger and compared with a predefinable setpoint temperature, wherein, if the actual temperature exceeds the setpoint temperature, said H₂O is admixed to the feedstock stream in order to bring the actual temperature into line with the setpoint temperature.

5. Method according to claim 3, characterized in that the instantaneous mass flow rate of the liquid H₂O to be mixed with the feedstock stream is measured prior to mixing with the feedstock stream, such a quantity of steam being added to the feedstock stream prior to mixing with the liquid H₂O that an instantaneous total content of H₂O in the feedstock stream resulting from the mixed-in liquid H₂O and the added steam is greater than or equal to a predefinable threshold value.

6. Apparatus for producing synthesis gas, having:
a furnace, which comprises a combustion chamber,
a reformer tube arranged in the combustion chamber for receiving a feedstock stream comprising hydrocarbon and steam,
a pipe connected to the reformer tube for feeding the feedstock stream into the reformer tube,
characterized by a means configured to introduce H₂O for cooling the feedstock stream into the pipe.

7. Apparatus according to claim 6, characterized in that said means comprises at least one nozzle for injecting said H₂O into the pipe.

8. Apparatus according to claim 6, characterized in that the pipe comprises a first and second portion, at least portions of the first portion of the pipe extending outside the combustion chamber and being connected to a heat exchanger arranged in the combustion chamber, and in particular at least portions of the second portion of the pipe extending outside the combustion chamber and connecting the heat exchanger to the reformer tube, and the first portion being of a length such that the H₂O introduced into the pipe is vaporized prior to entry into the heat exchanger.

9. Apparatus according to claim 8 characterized in that the combustion chamber comprises an upper and a lower region, the heat exchanger being arranged in the lower region.

10. Apparatus according to claim 9, characterized in that the reformer tube extends from the upper region of the combustion chamber into the lower region of the combustion chamber the reformer tube comprising an inlet in the upper region for feeding the feedstock stream into the reformer tube.

11. Apparatus according to claim 8, characterized in that the means for cooling the feedstock stream is arranged in the first portion of the pipe, said means in particular being arranged on a region of the first portion of the pipe lying outside the combustion chamber.

12. Apparatus according to claim 6, characterized in that the apparatus comprises an inflow line, via which the H₂O used for cooling may be supplied to said means.

13. Apparatus according to claim 12, characterized in that the inflow line comprises a valve.

14. Apparatus according to claim 13, characterized in that the apparatus comprises a control unit for controlling the valve, with a temperature sensor (12) provided on the second portion of the pipe for detecting an actual temperature of the feedstock stream prior to introduction of the feedstock stream into the reformer tube, the control unit being configured to control the valve in such a way that the actual temperature is brought into line with a predefinable setpoint temperature.

15. Apparatus according claim 13, characterized in that the apparatus comprises a measurement device for measuring an instantaneous mass flow rate of the H₂O to be introduced into the pipe, said measurement device being configured to measure said instantaneous mass flow rate upstream or downstream of the valve, the apparatus comprising a means for mixing the feedstock stream containing hydrocarbon and steam, the means for mixing the feedstock stream in being configured to obtain from the measurement device said instantaneous mass flow rate of the H₂O to be introduced into the pipe, and the means for mixing the feedstock stream being configured to add a sufficient quantity of steam to the feedstock stream prior to mixing with the H₂O for an instantaneous total content in the feedstock stream of H₂O resulting from the mixed-in H₂O and the added steam to be greater than or equal to a predefinable threshold value.
